(19) United States
(12) Patent Application Publication
(10) Pub. No.: US 2003/0229565 A1
(43) Pub. Date: Dec. 11, 2003

(54) Method and apparatus for selling a plurality of units

(76) Inventors: Sirish Reddi, London (GB); Rob Houghton, St. Albans (GB); Chirag Shah, London (GB)

Correspondence Address: HOGAN & HARTSON LLP, ONE TABOR CENTER, SUITE 1500, 1200 SEVENTEENTH ST, DENVER, CO, 80202, US

(21) Appl. No.: 10/202,614

(22) Filed: Jul. 23, 2002

Related U.S. Application Data
(63) Continuation-in-part of application No. 10/165,212, filed on Jun. 6, 2002.

(51) Int. Cl. G06F 17/60

(52) U.S. Cl. 705/37

(57) ABSTRACT

Method and apparatus for facilitating a sales transaction between one or more sellers and potential buyers in relation to large numbers of similar units. A seller offers the units to buyers, starting at an initial price. The potential buyers make offers to buy a given number of units at that price. The price is incrementally reduced, with buyers being given the opportunity to bid with each reduction. In other embodiments, the buyer makes an offer to multiple sellers at a given price, specifying the number of units the buyer wants. Sellers offer to fulfil some or the entire offer, and the buyer subsequently reduces the price and makes additional offers until the buyer's requirements are met.

### FIELD OF INVENTION

The present invention relates to the selling of goods and services by way of bidding by potential buyers.

The invention has been developed to enable multiple bidders to participate in an on-line auction in which a plurality of identical goods are offered for sale, and will be described herein with particular reference to this application. However, it will be appreciated that the invention is not limited to use in this context.

### BACKGROUND OF INVENTION

In a typical selling arrangement, a seller offers products to buyers at a given price. Potential buyers determine whether the price is acceptable, and if it is, purchase the product for that price. In the event the product is a commodity, there may be a bulk discount available. For example, the unit price for buying ten units might be 10% cheaper than that for a single unit. Also, depending upon the type of product involved and the nature and level of the transaction, there may be some opportunity for the buyer and seller to negotiate a mutually agreeable price for the number of units the seller is interested in acquiring.

In other selling paradigms, the buyer drives the price to a greater extent. A typical example is the auction, of which there are various types. A typical ascending auction is a time limited arrangement in which one or more potential buyers bid what they are willing to pay for a product. The buyer with the highest bid at the close of the auction is the successful purchaser at that price. Typically, each bid is considered a binding offer to buy at the bid price. Often, a reserve price is set by the seller. Bids below that price (which is usually not known to the buyers) are not sufficient to buy the product at the close of the auction.

An alternative approach is a descending auction, in which the buyer sets an initial price and periodically reduces it. Potential buyers are able to accept the price at any time. The tension in this case is between waiting for a low price and the possibility of another purchaser getting the product if one waits to long to bid. The rate at which the price is reduced depends upon the nature of the auction and the goods or services being sold.

A difficulty with known auction arrangements is that dealing with multiple identical units can be problematic. For example, each unit could be auctioned individually. However, where large numbers of units are to be sold, this can result in undesirable overheads associated with the selling process. The units can alternatively be sold as a single lot, but it will often be the case that the number of units for sale does not correspond with the precise needs of any particular buyer. A potential buyer therefore needs to buy more or less than the actual number of units required. Whilst it is possible for the seller to break the units into a number of smaller lots, this still requires the seller to have some knowledge of the needs of the potential buyers.

It is an object of the present invention to provide an auction-based method and apparatus for implementing sales of multiple identical or similar units to one or more potential buyers from one or more sellers.

### SUMMARY OF INVENTION

According to a first aspect of the invention, there is provided a method of using a computer to facilitate a sales transaction between one or more sellers and potential buyers in relation to a plurality of similar units, the method comprising the steps of:

(a) displaying an initial price per unit to the buyers;

(b) periodically and monotonically altering the price per unit and displaying it to the buyers;

(c) accepting from each of one or more of the buyers an offer to buy one or more of the units at the initial or any of the subsequent prices per unit, each offer being indicative of a number of units to be purchased at the price per unit that is current when that offer is submitted.

According to a second aspect of the invention, there is provided a method of using a computer to facilitate a sales transaction between a buyer and at least one potential seller in relation to a plurality of similar units, the method comprising the steps of, in the computer:

(a) receiving a first offer from a buyer, the offer being indicative of a number of units the buyer wishes to purchase and the price per unit the buyer is willing to pay;

(b) presenting the offer to a plurality of sellers of the units;

(c) receiving from each of the sellers an indication of the numbers of units that seller is willing to sell at the price per unit in the offer;

(d) in the event the sellers offer, in aggregate, enough units to satisfy the number of units requested by the buyer, sending a message to the buyer confirming the sale of the units by respective sellers;

(e) in the event the sellers do not offer, in aggregate, enough units to satisfy the number of units requested by the buyer:

(i) accepting the units offered in aggregate by the sellers so far; and

(ii) accepting a further offer from the buyer, the offer being indicative of the number of units the buyer still wishes to purchase and a higher price per unit the buyer is willing to pay; and

(f) repeating steps (b) to (e).

Preferably, steps (b) to (e) are repeated until:

the buyer is satisfied with the number of units accepted;

the buyer reaches a maximum price per unit; or

a time limit for the transaction expires.

In accordance with yet another aspect of the present invention recedence of the sellers' offers for sale of the units is at least partially determined on the basis of the chronological order in which they are received, such that earlier offers are accepted prior to later offers at that price.

In a third aspect of the present invention, there is provided computer apparatus configured and programmed to facilitate a sales transaction between one or more sellers and potential buyers in relation to a plurality of similar units, the computer apparatus including:

(a) display means for displaying an initial price per unit to the buyers;

(b) means for periodically and monotonically altering the price per unit, and providing the altered price per unit to the display means for display to the buyers;

(c) means for accepting from each of one or more of the buyers an offer to buy one or more of the units at the initial or any of the subsequent prices per unit displayed to the buyers, each offer being indicative of a number of units to be purchased at the price per unit that is current when that offer is submitted.

According to a fourth aspect of the present invention, there is provided computer apparatus configured and programmed to facilitate a sales transaction between a buyer and at least one potential seller in relation to a plurality of similar units, computer apparatus including:

(a) means for receiving a first offer from a buyer, the offer being indicative of a number of units the buyer wishes to purchase and the price per unit the buyer is willing to pay;

(b) means for presenting the offer to a plurality of sellers of the units;

(c) means for receiving from each of the sellers an indication of the numbers of units that seller is willing to sell at the price per unit in the offer;

the computer apparatus being configured to:

(d) in the event the sellers offer, in aggregate, enough units to satisfy the number of units requested by the buyer, send a message to the buyer confirming the sale of the units by respective sellers;

(e) in the event the sellers do not offer, in aggregate, enough units to satisfy the number of units requested by the buyer:

(i) accept the units offered in aggregate by the sellers so far; and

(ii) accept a further offer from the buyer, the offer being indicative of the number of units the buyer still wishes to purchase and a higher price per unit the buyer is willing to pay;

(f) repeat the steps of offering and acceptance by the buyers and sellers.

Other aspects and embodiments of the invention are disclosed in the following detailed description and in the dependent claims that follow.

### BRIEF DESCRIPTION OF DRAWINGS

Preferred embodiments of the invention will now be described, by way of example only, with reference to the accompanying drawings, in which:

FIG. 1 shows apparatus for implementing a sales transaction between a seller and a plurality of potential buyers, in accordance with the invention;

FIG. 2 shows a log of a series of offers that have taken place during a series of transactions between a seller and plurality of buyers;

FIG. 3 is a screen image showing an extract of a seller's records in relation to a plurality of transactions over four months, the transactions being in accordance with the present invention;

FIG. 4 is a screen image showing an extract of a buyer's records in relation to the transactions shown in FIG. 3 in relation to a seller;

FIG. 5 an input screen for allowing management of transactions in accordance with the invention;

FIG. 6 is a flowchart illustrating an embodiment of a method of implementing a transaction between a seller and one or more potential buyers; and

FIG. 7 is a flowchart illustrating an embodiment of a method of implementing a transaction between a buyer and a plurality of sellers.

### DETAILED DESCRIPTION OF PREFERRED EMBODIMENT

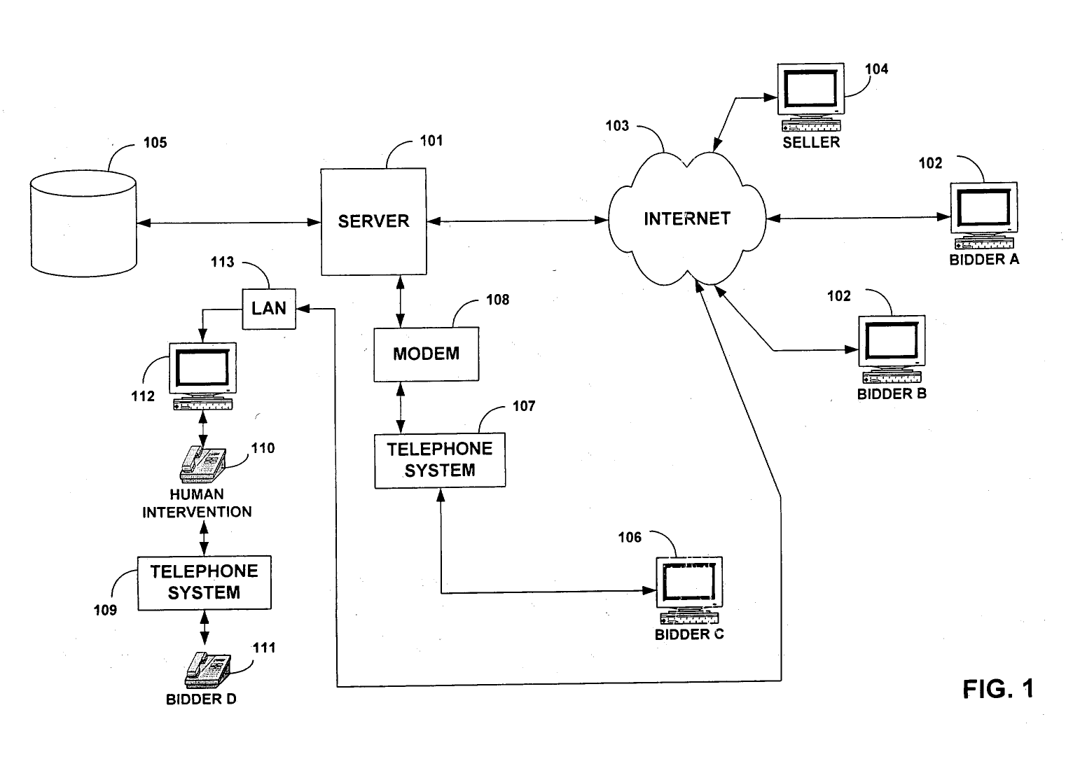

FIG. 1 shows an arrangement 100 in which a central computer in the form of a server 101 associated with a seller is configured to facilitate a sales transaction between the seller and potential buyers. The potential buyers, in this case, are Bidders A, B, C and D. Bidders A & B are in communication with the server 101 via a communication network 103. In this case, the network is the Internet, but it will be appreciated that some or all of the network can be a Local Area Network (LAN), Wide Area Network (WAN), or that the arrangement can be configured to enable any or all of the Bidders to dial in directly via a modem. Each of Bidders A & B have an associated computer 102 that enables them to communicate with the server 101.

Bidder C dials directly into the server 101 via a public telephone system 107 and modem 108. Bidder D, by contrast, rings an agent of the seller using the telephone system 109 (which can be the same as telephone system 107). The agent (not shown) explains what is happening verbally to Bidder D via the telephones 110 and 111, and accepts bids manually and inputs them into the server via a computer 112 and LAN 113.

The server 101 is also in communication, via the internet, with a terminal 104 that the seller can use to access and set up transactions, and to monitor and amend transactions already in progress. The server also has access to a database 105 that maintains a record of the Bidders' account details, the prices of various units being sold, and other necessary information, as described in more detail below.

It will be understood that the words “identical” and “similar” within this specification are intended to cover all situations in which units are similar enough to each other that a buyer would consider them effectively a commodity. For example, if the units were second-hand hub-caps for a particular model car, the fact that there may be some minor differences between individual units due to manufacture date or general wear might not be considered enough of a difference by purchasers for the units to be considered anything other than identical.

The term “unit” within this specification is intended to cover any grouping for the purposes of sale, in any unit of measurement. This would include, for example, individual products such as the hubcaps previously described, as well as products measured by weight or volume. For example, a “unit”, when referring to fair average quality wheat, could be a bushel of wheat or a tonne of wheat, or any other suitable measure. In the hubcap case, a “unit” could alternatively be defined by the seller as being a set of four hubcaps for sale as a lot. The word “unit” also includes services, which can be expressed in units of time or per job. An example would be a cleaning service offering a price per average room or per hour for, say, a given week or month. The concept of units is intended to apply to the seller. As described in relation to one embodiment below, the buyers can be presented with a translated version of the units being sold, even to the point where different buyers see different units compared to each other, yet are effectively bidding on the same seller-based units.

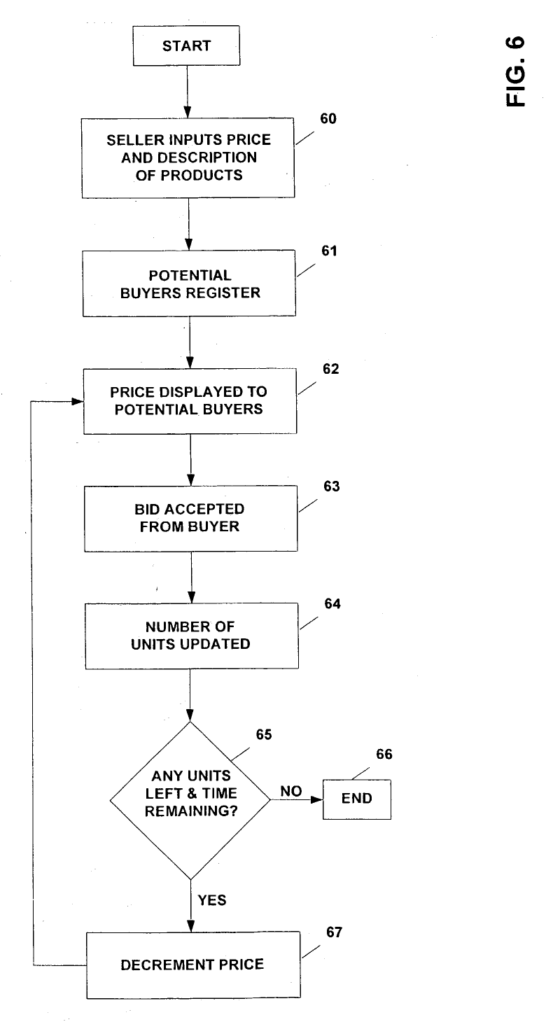

Initially, the seller sets up an auction of a plurality of identical units (FIG. 6, step 60). This can be achieved by entering appropriate data into the relevant fields in a setup screen (not shown). The data includes a description of the product suitable for the type of auction. For example, in the case where the auction takes place frequently, selling to experienced buyers or those who have access to a catalogue, the description can be concise or even just refer to a lot number or serial number. For more public or occasional auctions, it will usually be desirable to provide a more detailed explanation of the units on sale.

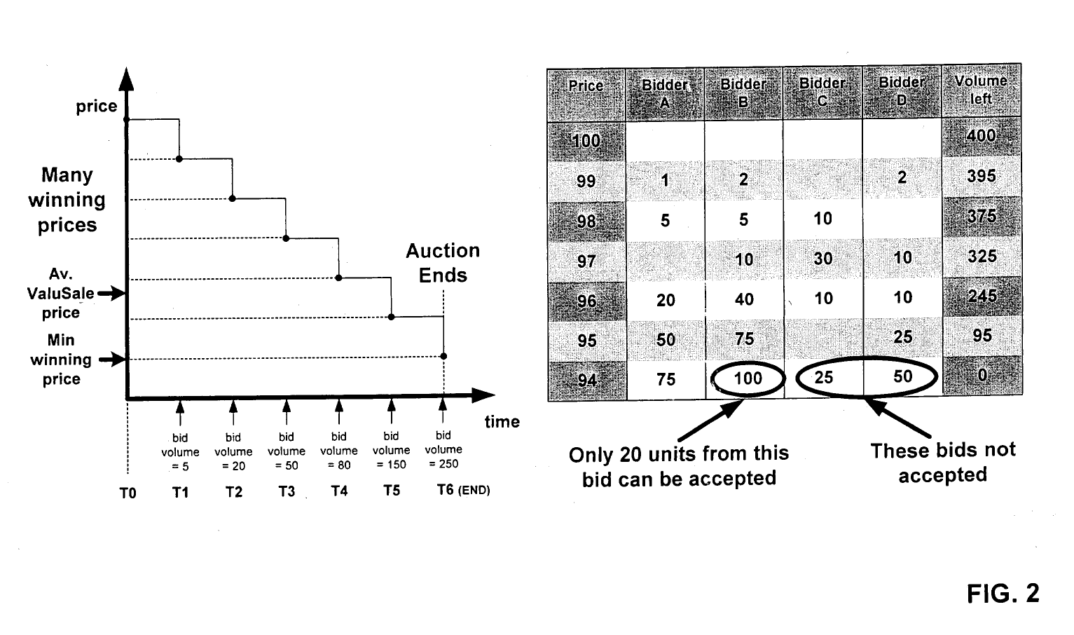

In the example shown in FIG. 2, the seller has 400 units to sell, and sets an initial price of £100.

In the preferred embodiment, all prospective Bidders A-D wishing to bid in the auction must register (step 61) beforehand. Typically, this will be done by inputting an identity and password to a login screen displayed on the respective computers 102. For Bidders that are known to the seller, this login confirms the Bidder's responsibility for any bids lodged. In other embodiments, Bidders can register for a one-off session by filling suitable details. In many cases, the registration process will require the potential Bidder to provide some indication of their bona fides as a purchaser, such as credit card details. This is particularly the case in one-off or infrequent auction events, such as online bidding for unique units via the Internet. By registering these details, it is considerably more difficult for any Bidder to renege on a bid once the seller he seller has accepted it.

Typically, the auction will be scheduled to start at a particular time. In one embodiment, only those Bidders that are registered by then can participate. However, in many cases it will be desirable to allow other Bidders to register whilst the auction is in progress.

At the scheduled start time TO, the starting price is displayed (step 62) to the Bidders. This can be achieved, for example, by software on the Bidder's computer requesting the price, or by the server 101 actively pushing the data to the Bidders computers 102. In the example of FIG. 2, the initial price is £100, which is displayed to each of the Bidders A-D. At this price, none of the Bidders is interested, so there are no bids.

At T1, the price is lowered by the seller to £99. This can be done manually or implemented automatically in software. At this price, Bidder A wants 1 unit, Bidder B wants 2 units and Bidder D wants 2 units. Bidder C is still not interested in purchasing at this price. Since the price is already determined at any given time, each of the interested Bidders can indicates their acceptance of that price simply by entering a number of units they want to purchase into a suitable field in application running on the respective computer 102. Typically, the application running on the computers 102 associated with the respective bidders will prompt the Bidder to confirm the amount by taking the present price, multiplying it by the number of units entered by the bidder and then displaying the result to ensure the Bidder is sure of the overall price to be paid for the offer. The server 101 accepts the bid (step 63) then updates the number of units left (step 64). If there are no units left (step 65), the seller closes (step 66) the auction (either automatically, via the software running on the server 101, or manually) and informs the Bidder accordingly.

If, as in the present case, there are units left and the time for the auctions has not expired (step 65), then time T2, the price per unit is again dropped (step 67), this time to £98 and the process returns to step 62.

It should be noted that although the price per unit is decremented evenly in this example, this need not be the case. For example, it will often be the case that the price will drop relatively quickly at first, then drop more slowly per increment as the average price of the units is reached, then either continue at that rate or fall relatively quickly again once interest appears to have waned. In any event, after T2, Bidder A wants 5 units, Bidder B wants 5 units and a Bidder C wants 10 units. Bidder D does not want any units at this price, perhaps having noted that there is still a substantial number of the units left. After this round of bidding, there are 375 units left for sale.

The rounds continue in this way, with each of Bidders A, B, C and D purchasing different amounts of the unit at each price as it decrements through times T3 to T6. T6 represents the closing time of the auction, so T5 is the last decrement after which the Bidders can purchase goods. In this case, immediately prior to T5, there are 95 units left. As the price drops to £94 at T5, Bidder A tries for 75 units, Bidder B for 100, Bidder C for 25 and Bidder D for 50. Clearly all of these requirements cannot be met, since there are only 75 units left to fulfil bids for 250 units. There are a number of ways in which this issue can be with. In the preferred embodiment, the Bidders offers were received in the order A, B, C, D, and priority is awarded accordingly. Bidder A therefore gets all 75 of the remaining 95 units. Bidder B, having requested 100 units, is allocated the remaining 20 units, and the remaining offers from Bidders C and D remain unfulfilled.

There are a number of alternative scenarios for dealing with the problem of final bids exceeding the remaining number of units. It will be appreciated that the issue can arise prior to the scheduled time of the auction; once there are no units left, the auction is over. One way to manage the problem is to provide a priority system, such that certain buyers are given priority over others. This can be based on, for example, a previous commercial relationship (ie, those with a longer or more profitable relationship with the seller can be given seniority by the seller), the order in which the Bidders register for the auction or some random or other function that allocates seniority to the Bidders. However, the most likely alternative is to make a decision based either on the time the offer is received (first in, first served) or waiting until the next time period elapses and giving priority to the Bidder in order of those asking for the most units.

Also, in the case where the number of units remaining is insufficient to satisfy an offer, the system can be configured to make a counter-offer to the bidder confirming that the smaller number of units than those requested at the price is still acceptable. Typically, this counter-offer would be live for a predetermined time, then withdrawn and the bidders informed that the remaining units are still on the market at the price. The price can then be decremented again if there is no, or insufficient, interest to sell all remaining units.

It will be noted that even though only a small proportion of the units were sold at a relatively high price, the average price received by the seller for the goods is still higher than would have been the case if the seller had sold at the price reached immediately before the auction finished.

If the scheduled auction time is reached without all the units having been sold, then the units are withdrawn from sale. Naturally, the auction can be attempted again at a future date with the remaining units, either alone or in combination with other similar units. Alternatively, the seller can use information logged during the auction to determine which, if any, of the Bidders might be interested in off-line negotiation for the remaining units.

It will be appreciated that the offers of various bidders can be accepted in any suitable way, including directly via SMS text messaging, e-mail, personal internet messaging systems, public paging systems, DTM (dual tone modulation) via touch-tone telephones, telephonic voice recognition systems or any other suitable remote data entry system. Some or all of the communication can be via landline or radio communication.

Other non-direct methods can be used, whereby a bidder supplies information to the seller or an agent of the seller, and the agent or the seller input the data directly into the computer system on the bidder's behalf.

The preferred embodiment has been described in the context of a real-time online system. However, it will be appreciated that the system can be configured such that bidders can pre-register for an auction and them pre-program their responses to particular circumstances. Proxy bidding is also allowed, in which a number of units for each possible price are preprogrammed, and offers made for the correct number of units at each price are then automatically sent to the server as each respective price is reached.

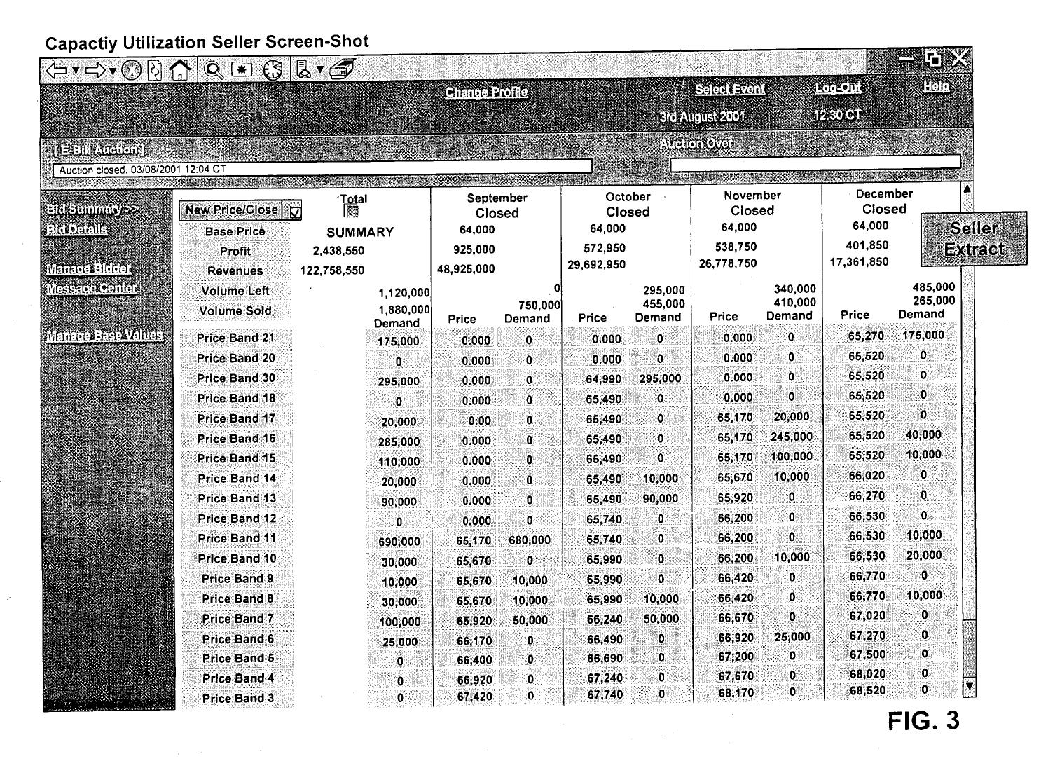

In an alternative embodiment, such as that illustrated in FIG. 3, the system is configured to allow management of profit. In the illustrated embodiment, this is achieved by allowing the seller to input a base price (in FIG. 3, $64.000 per unit) and restricting the price per unit to a predetermined level above that to cover overheads and ensure a minimum profit. This can be extend to restrict to a maximum or minimum the number of units any bidder can make an offer for at any or all prices, to cover the costs of higher overheads for smaller lots or to ensure that differing costs associated with different supply costs are covered. For example, if the seller is on-selling units from another supplier and the price the supplier will charge depends upon the total number of units sold, it is possible to demand that minimum orders be input, especially at lower prices where profits are correspondingly lower.

FIG. 3 also shows a summary of trading for September to December in a particular year, for a single product type. The first column 30 shows price bands which, it will be noted, no not necessarily represent equal prifces per unit in different months. For example, in September, price band 11 is £65.170 whilst in October it is £65.740. For each month, each price band shows a totoal demand, in units, for the product at each price band. In November, for example, at price band 6 (£66.920), there was an order for 25,000 units. A summary of the total profit, revenue, volume left and volume sold is shown at the top of the column for each month, and a total for all months shown at the top of column headed SUMMARY.

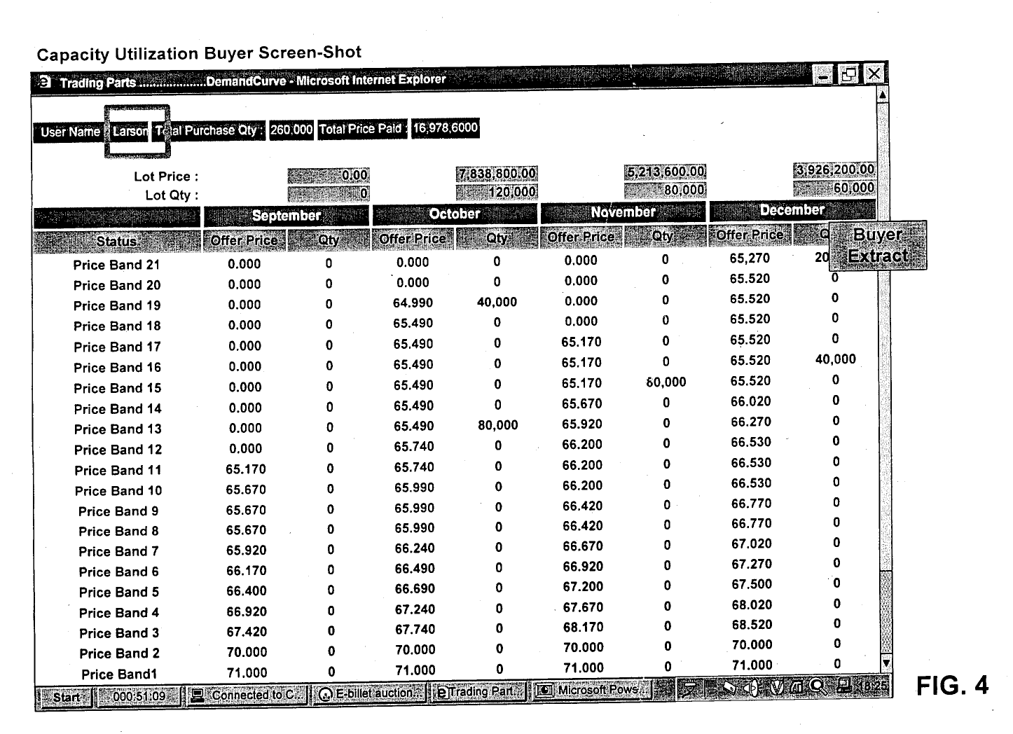

The buyers are also able to obtain a summary of their transactions, as shon in FIG. 4. It will be noted that the October purchase in price band 19 (£64.990)) for this buyer was 40,000 units, of the total 295,000 units sold at that price point overall (as shown in FIG. 3). At the top of each montly column in FIG. 4, there is also shown a summary of the price paid in each month and the number of units purchased.

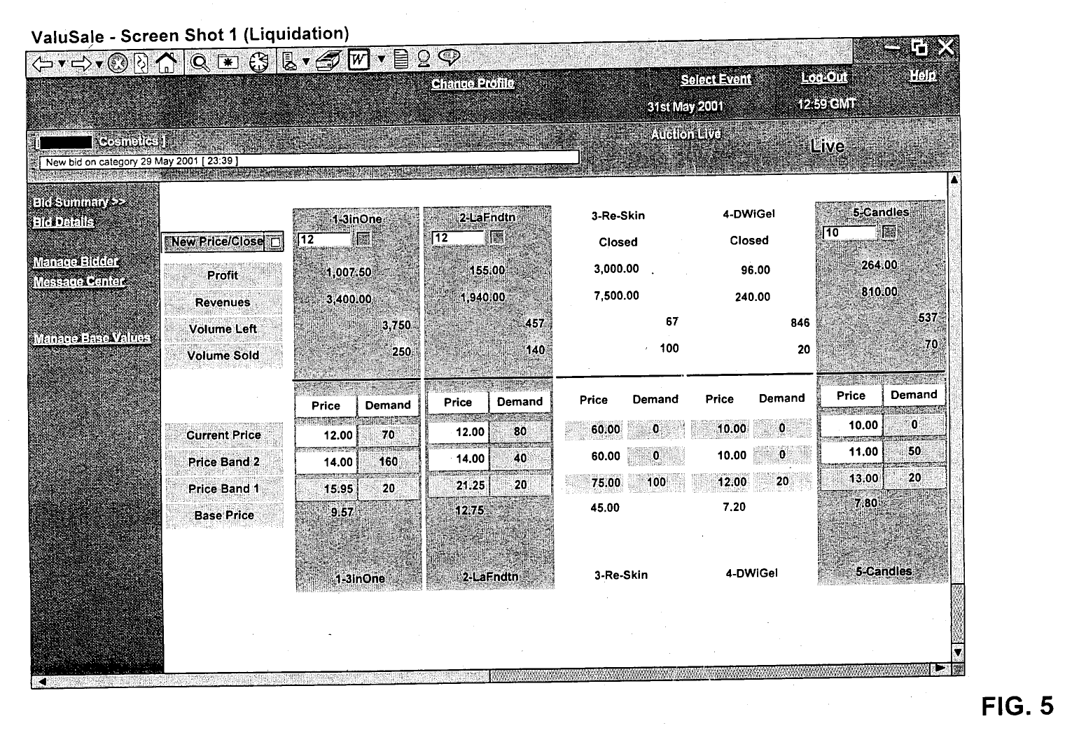

FIG. 5 shows a management screen accessible by the seller to manage and set up auctions. There are presently 5 auctions displayed; auctions 1, 2 and 5 are still pending, with present prices per unit of 12, 12 and 10 respectively. Auctions 3 and 4 are closed. The screen in FIG. 5 shows the profit, revenues, volume left and volume sold for each auction. It also summarises the current price (which is the closing price for closed auctions) and earlier prices, and the units purchased by bidders at those prices. Finally, a base price is shown for each unit, upon which the profit and revenue figures are based.

It will be noted that a New Price/Close button 40 is provided. This enables the manual inputting of a new price, as well as closing of the auction for any reason. It will be appreciated that these features can be set to run automatically to avoid, as far as possible, the need for human intervention.

It will be appreciated that in a preferred embodiment, the system can be configured to generate invoices directly from logs generated during the auction, as well as to provide an audit trail for accounting purposes.

It will also be understood that various forms of security, including encryption of various types known to those skilled in the art, can be applied to ensure confidentiality between the seller and bidders. Also, the seller can implement other forms of control, such as excluding certain bidders for undesirable behaviour, or can, at its discretion, remove or modify an offer from a Bidder at a particular price. Typically this will arise where there has been an obvious error by the Bidder. It is also usual that the error should be rectified prior to the next price decrement, to ensure fairness to the remaining bidders and the seller.

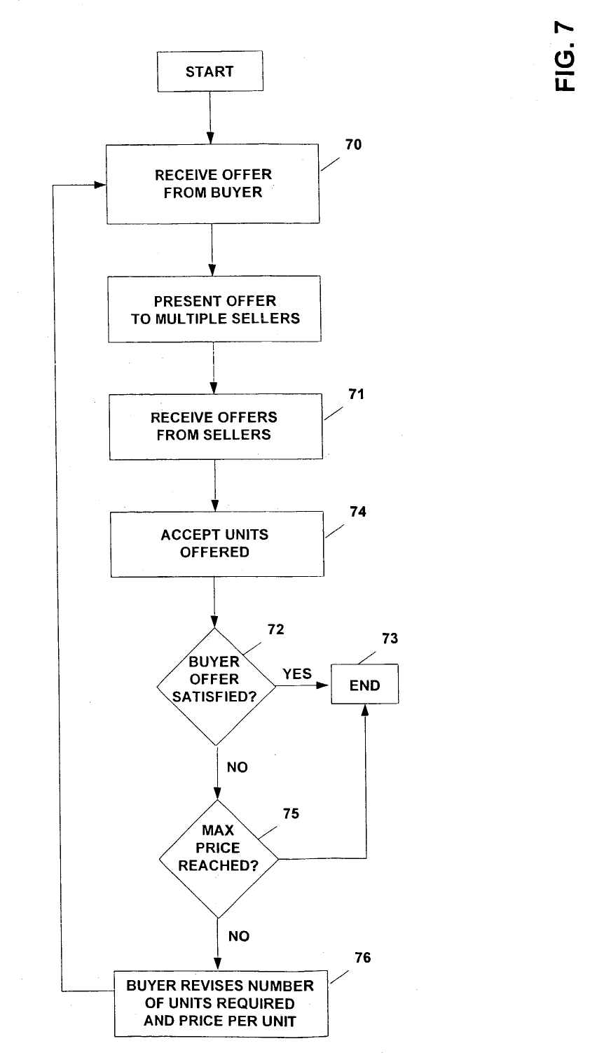

Referring to FIG. 7, in an alternative embodiment, a buyer can use the system to negotiate a transaction to purchase multiple units from two or more sellers. In this case, the buyer uses an application, typically running in a web-based environment, to access a portal website that brings together multiple vendors of identical goods. The buyer (via the application) sends an offer (step 70) to all sellers to buy units at a first price. Each seller responds (step 71) by informing the buyer how many units it is willing to provide at that price. If the buyer can fulfil its requirements (step 72) at that price point, then the order is confirmed and the transaction is finished (step 73). If there is an oversupply at the price, then a mediation function can be applied, as was used in the previous embodiment when there were not enough units left to satisfy all offers from the Bidders.

In the event the buyers requirements are not met, then the units offered are accepted (step 74). Assuming the buyer's maximum price has not yet been reached (step 75), the number of items required and the price per item are revised (step 76) by the buyer and resubmitted to the sellers (step 70). Again, the sellers respond with an indication of how many units will be supplied at the price.

These steps are repeated until the buyer's requirements are fulfilled or the buyer reaches the maximum price it is willing to pay. In alternative embodiments there can be a time limit by which the transaction must be completed as well.

Many other aspects of the previous embodiment can also be applied to this embodiment, such as proxy bidding. However, by its nature, the embodiment in which the buyer is singular may require coordinating functionality to be provided by an intermediate third party, which in the example would be disposed within or adjacent the portal through which the buyer accesses the sellers. It will be appreciated that a third party can also coordinate the process where there are multiple buyers and a single seller. This would avoid the need for the seller to coordinate the entire process.

Also, non-participatory observers can be allowed, with or without the need to log-in and with or without the ability to comment via any messaging system.

In yet another embodiment, a seller auctions units of some measurement, which are presented to buyers as units in another measurement. Different buyers can bid at each price for the units An example of this embodiment is an aluminium extrusion plant that wishes to auction spare capacity. The capacity is essentially time-based, but buyers are more likely to be interested in buying lengths of, say, a certain extrusion. When the auction is being established, the seller (or buyers) define a mapping between units of capacity of the plant and the particular extrusions the different buyers are bidding on.

For example, a first bidder wants to bid on one type of extrusion that takes one hour per foot, and another bidder wants to bid on a different extrusion that takes two hours per foot. The plant has a certain number of hours it is willing to auction. Rather than have the individual buyers bid for units of production hours, an application running on the buyers' computers translates the price per hour into a price per foot of extrusion, and back again as requred. So, 100 hours offered by the plant becomes 100 feet for the first bidder and 50 feet for the second bidder. The bidders can then input how many units they want to buy at the present price. The units that they input are in feet, which is translated back to hours for use by the seller. In this way, the units being bid on by the bidders are different from their point of view (once the mapping is in place), but the same from the seller's point of view. It will be understood by those skilled in the art that the mapping can take place at any point in the computer apparatus, and can be set up by the buyer, seller or an intermediary.

It will be appreciated that all forms of the invention can have additional features, such as real-time messaging between any combination of bidders and sellers. Important system notifications, such as countdowns to price changes and the finishing time can also be sent to users of the system.

Although the invention has been described with reference to a number of specific embodiments, it will be appreciated by those skilled in the art that the invention can be embodied in many other forms.

1. A method of using a computer to facilitate a sales transaction between one or more sellers and potential buyers in relation to a plurality of similar units, the method comprising the steps of:
(a) displaying an initial price per unit to the buyers;
(b) periodically and monotonically altering the price per unit and displaying it to the buyers;
(c) accepting from each of one or more of the buyers an offer to buy one or more of the units at the initial or any of the subsequent prices per unit, each offer being indicative of a number of units to be purchased at the price per unit that is current when that offer is submitted.

2. A method according to claim 1, wherein step (c) includes accepting offers from a plurality of the buyers at a given price.

3. A method according to claim 1, wherein step (b) comprises monotonically decreasing the price per unit.

4. A method according to claim 2, wherein step (c) is performed by the seller at a rate that changes based on a rate at which offers are received from the buyers.

5. A method according to claim 4, wherein, in the event the seller has received offers to buy a number of units that falls outside a predetermined band of numbers of units for a given price, the rate at which the price is altered in step (c) is changed.

6. A method according to claim 1, including the step of registering the buyers with the computer prior to allowing them to place an offer to purchase one or more of the units.

7. A method according to claim 6, wherein registering of a buyer includes determining account details for the buyer, such that the payment for units can be taken by the seller once an offer by a buyer has been made and accepted.

8. A method according to claim 1, further including the step of:
accepting one or more proxy bids, each proxy bid including at least one proxy price per unit and a number of units at that price; and
accepting the offer for the number of units associated with each price once that price is reached.

9. A method according to claim 8, wherein the proxy bid is executed only if the number of units associated with the proxy price is still available.

10. A method according to claim 1, wherein steps (a) and (b) include displaying to the buyers a minimum acceptable number of units for which buyers must bid, for at least some of the displayed prices.

11 A method of using a computer to facilitate a sales transaction between a buyer and at least one potential seller in relation to a plurality of similar units, the method comprising the steps of, in the computer:
(a) receiving a first offer from a buyer, the offer being indicative of a number of units the buyer wishes to purchase and the price per unit the buyer is willing to pay;
(b) presenting the offer to a plurality of sellers of the units;
(c) receiving from each of the sellers an indication of the numbers of units that seller is willing to sell at the price per unit in the offer;(d) in the event the sellers offer, in aggregate, enough units to satisfy the number of units requested by the buyer, sending a message to the buyer confirming the sale of the units by respective sellers;
(e) in the event the sellers do not offer, in aggregate, enough units to satisfy the number of units requested by the buyer:
(i) accepting the units offered in aggregate by the sellers so far; and
(ii) accepting a further offer from the buyer, the offer being indicative of the number of units the buyer still wishes to purchase and a higher price per unit the buyer is willing to pay; and
(f) repeating steps (b) to (e).

12. A method according to claim 11, wherein steps (b) to (e) are repeated until:
the buyer is satisfied with the number of units accepted;
the buyer reaches a maximum price per unit; or
a time limit for the transaction expires.

13. A method according to claim 11, wherein step (b) is performed at fixed and predetermined time intervals after the initial offer is made by the buyer.

14. A method according to claim 11, including the step of registering the buyer with the computer prior to allowing the initial offer to be placed, wherein registering of the buyer includes determining account details for the buyer, such that the payment for units can be provided to the successful sellers once an offer by a buyer has been made and accepted by one or more of the sellers.

15. Computer apparatus configured and programmed to facilitate a sales transaction between one or more sellers and potential buyers in relation to a plurality of similar units, the computer apparatus including:
(a) display means for displaying an initial price per unit to the buyers;
(b) means for periodically and monotonically altering the price per unit, and providing the altered price per unit to the display means for display to the buyers;
(c) means for accepting from each of one or more of the buyers an offer to buy one or more of the units at the initial or any of the subsequent prices per unit displayed to the buyers, each offer being indicative of a number of units to be purchased at the price per unit that is current when that offer is submitted.

16. Computer apparatus according to claim 15, wherein the means for accepting offers is configured to determine precedence of the buyers' offers at least partially on the basis of the chronological order in which they are received, such that earlier offers are accepted prior to later offers at that price.

17. Computer apparatus according to claim 15, wherein the means for accepting offers is configured to determine precedence of the buyers' offers at least partially on the basis of the number of units indicated by each of the offers, such that offers for larger numbers of units take precedence over offers for lower numbers of units at that price.

18. Computer apparatus according to claim 15, including means for registering the buyers prior to allowing them to place an offer to purchase one or more of the units, wherein registering of a buyer includes determining account details for the buyer, such that the payment for units can be taken by the seller once an offer by a buyer has been made and accepted.

19. Computer apparatus according to claim 15, further including means for logging the prices per unit and offers at the prices per unit.

20. Computer apparatus configured and programmed to facilitate a sales transaction between a buyer and at least one potential seller in relation to a plurality of similar units, computer apparatus including:
(a) means for receiving a first offer from a buyer, the offer being indicative of a number of units the buyer wishes to purchase and the price per unit the buyer is willing to pay;
(b) means for presenting the offer to a plurality of sellers of the units;
(c) means for receiving from each of the sellers an indication of the numbers of units that seller is willing to sell at the price per unit in the offer;
the computer apparatus being configured to:
(d) in the event the sellers offer, in aggregate, enough units to satisfy the number of units requested by the buyer, send a message to the buyer confirming the sale of the units by respective sellers;
(e) in the event the sellers do not offer, in aggregate, enough units to satisfy the number of units requested by the buyer:
(i) accept the units offered in aggregate by the sellers so far; and
(ii) accept a further offer from the buyer, the offer being indicative of the number of units the buyer still wishes to purchase and a higher price per unit the buyer is willing to pay;
(f) repeat the steps of offering and acceptance by the buyers and sellers.
